(19) United States
(12) Patent Application Publication
(10) Pub. No.: US 2026/0296319 A1
(43) Pub. Date: Oct. 1, 2026

(54) IMAGING APPARATUS

(71) Applicant: HONDA MOTOR CO., LTD., Tokyo (JP)

(72) Inventors: Gakuyo Fujimoto, Wako-shi (JP); Misako Koike, Wako-shi (JP); Tsugihiro Hamasuna, Tokyo (JP)

(73) Assignee: HONDA MOTOR CO., LTD., Tokyo (JP)

(21) Appl. No.: 19/545,163

(22) Filed: Feb. 20, 2026

(30) Foreign Application Priority Data
Mar. 28, 2025 (JP) 2025-056638

(51) Int. Cl. B60R 1/29

(52) U.S. Cl. CPC B60R 1/29; B60R 2300/105; B60R 2300/8006

(57) ABSTRACT

There is provided with an imaging apparatus. A plurality of imaging apparatuses includes optical sensors provided inside a mobile object and arranged to capture a face image of an operator inside the mobile object. The plurality of imaging apparatuses are arranged at positions corresponding to a plurality of assumed face directions of the operator during an operation of the mobile object.

### CROSS-REFERENCE TO RELATED APPLICATION(S)

This application claims priority to and the benefit of Japanese Patent Application No. 2025-056638, filed on Mar. 28, 2025, the entire disclosure of which is incorporated herein by reference.

### BACKGROUND OF THE INVENTION

### Field of the Invention

The present invention relates to an imaging apparatus.

### Description of the Related Art

Conventionally, in a mobile object such as a vehicle, there is technology for utilizing a captured image obtained by imaging an operator riding on the mobile object for various controls of the mobile object. Japanese Patent Laid-Open No. 2008-189230 discloses technology for providing a layout suitable for capturing a face image by arranging a camera device to be attached to a supporter.

### SUMMARY OF THE INVENTION

According to one embodiment of the present invention, an imaging apparatus comprises: a plurality of imaging apparatuses including optical sensors provided inside a mobile object and arranged to capture a face image of an operator inside the mobile object, wherein the plurality of imaging apparatuses are arranged at positions corresponding to a plurality of assumed face directions of the operator during an operation of the mobile object.

### BRIEF DESCRIPTION OF THE DRAWINGS

FIG. 1 is a side view illustrating an outline of a vehicle in which an imaging apparatus according to the present embodiment is disposed;

FIG. 2 is a block diagram illustrating an example of a hardware configuration of the imaging apparatus;

FIG. 3 is a diagram illustrating an example of arrangement of the imaging apparatus; and

FIG. 4 is a diagram for explaining an example of an imaging apparatus used for a direction of a face of a driver in a vehicle.

### DESCRIPTION OF THE EMBODIMENTS

Hereinafter, embodiments will be described in detail with reference to the attached drawings. Note, the following embodiments are not intended to limit the scope of the claimed invention, and limitation is not made to an invention that requires a combination of all features described in the embodiments. Two or more of the multiple features described in the embodiments may be combined as appropriate. Furthermore, the same reference numerals are given to the same or similar configurations, and redundant description thereof is omitted.

The technology described in Japanese Patent Laid-Open No. 2008-189230 is based on the premise that a driver facing forward is imaged, and does not assume that the driver changes the direction of their face. For this reason, there is a problem that it is not possible to cope with cases where an operator faces various directions.

Therefore, an object of the present invention is to accurately estimate the face direction and the gaze direction even when the face direction of the operator changes.

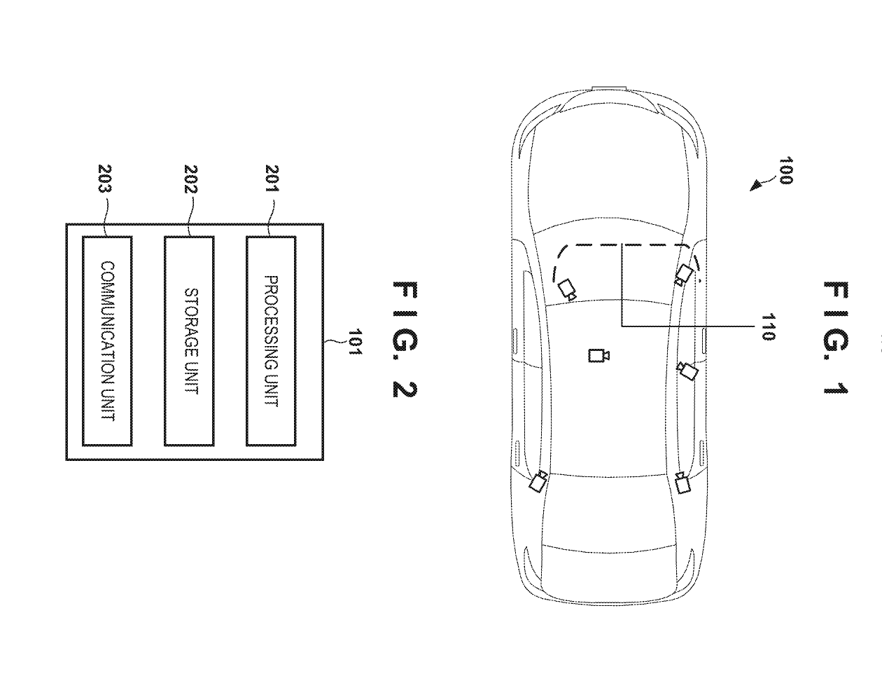

FIG. 1 is a bird's eye view illustrating an outline of a vehicle 100 which is a mobile object in which an imaging apparatus according to an embodiment of the present invention is disposed. In FIG. 1, a plurality of imaging apparatuses 110 are disposed inside the vehicle 100. The imaging apparatus 110 according to the present embodiment includes an optical sensor and is disposed so as to capture a face image of an operator inside the mobile object. Further, each imaging apparatus 110 illustrated in FIG. 1 is connected to an information processing device (ECU) 120 provided in the vehicle so as to be able to transmit and receive information. Each information processing described below is described as being executed mainly by the imaging apparatus 110, but a part of the processing may be executed by the ECU 120 as long as similar processing can be executed.

The vehicle 100 according to the present embodiment is a mobile object that stores an operator inside the mobile object and executes drive control according to an operation by the operator. In the present embodiment, the description will be given assuming that the vehicle 100 is a sedan-type four-wheeled passenger vehicle, but a mobile object different from the vehicle may be adopted as long as similar processing can be executed.

As described above, the plurality of imaging apparatuses 110 according to the present embodiment are provided inside the vehicle 100, and each of the imaging apparatuses is arranged to capture a face image of an operator inside the vehicle 100. Hereinafter, it is assumed that the operator is a driver of the vehicle 100. The imaging apparatus 110 according to the present embodiment is arranged at each position corresponding to a plurality of assumed face directions of the driver during driving.

FIG. 2 is a block diagram illustrating an example of a hardware configuration of the imaging apparatus according to the present embodiment. The imaging apparatus 110 includes a processing unit 201, a storage unit 202, and a communication unit 203. The processing unit 201 is a processor represented by a CPU, and executes a program stored in the storage unit 202. The storage unit 202 is a storage device such as a RAM, a ROM, or a hard disk. The communication unit 203 includes a wired or wireless communication interface capable of communicating with an external device such as another electric vehicle via a communication network. The program stored in the storage unit 202 also includes an application program for using a system according to the present embodiment.

The storage unit 202 stores various data in addition to the program executed by the processing unit 201. The storage unit 202 according to the present embodiment stores a captured image captured by the imaging apparatus 110, and a face direction or a gaze direction estimated by provisional estimation processing and main estimation processing described later.

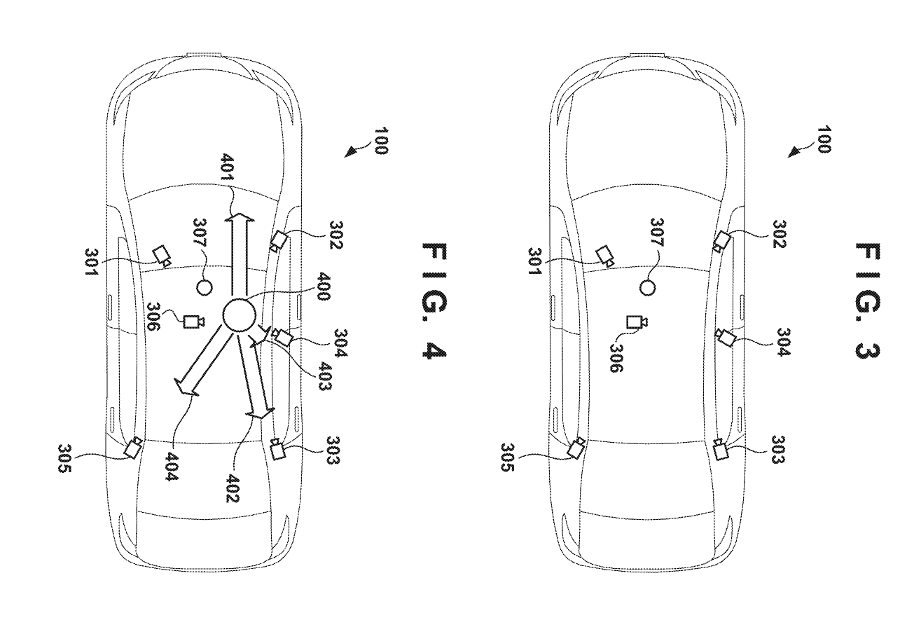

Hereinafter, the imaging apparatuses 110 arranged at positions corresponding to a plurality of assumed face directions of the driver will be described with reference to FIG. 3. The imaging apparatuses 110 illustrated in FIG. 3 include seven imaging apparatuses 301 to 307. Here, the assumed face direction of the driver can be, for example, a face direction assumed when the driver operates the vehicle 100. Furthermore, for example, the assumed face direction of the driver can be, for example, a face direction assumed when the driver confirms the surroundings of the vehicle 100 or the peripheral monitoring device included in the vehicle. Here, the peripheral monitoring device included in the vehicle is assumed to be a mirror, particularly, a side mirror. However, the peripheral monitoring device may be, for example, a display device (for example, displaying environment information during a parking operation) included in the vehicle.

Further, the imaging apparatus 110 may be arranged within a range of the face direction (assumed range of the face direction) assumed during the operation of the vehicle 100. Here, for example, a range of the face direction is assumed in each of a yaw direction (lateral direction) and a pitch direction (longitudinal direction), and the imaging apparatus 110 may be arranged within the range. Here, for example, each of a range from a left door mirror to a right C-pillar (or a right D-pillar) through the windshield side in the yaw direction and a range from a rearview mirror to a meter panel in the pitch direction may be the assumed range of the face direction. Hereinafter, a specific example of a position where such an imaging apparatus is disposed will be described with reference to FIG. 3.

In FIG. 3, the imaging apparatus 301 is an imaging apparatus corresponding to a position of a gaze when the driver confirms a left door mirror, and is disposed on a dashboard in front of a passenger seat. Here, the imaging apparatus 301 is located at the left end of the assumed range of the face direction in the yaw direction. The imaging apparatus 301 is disposed at a position and in a posture assumed to face the driver when the driver confirms the left door mirror. Therefore, the imaging apparatus 301 is disposed in a posture of imaging a position of the driver's seat where the face of the driver is assumed to exist. The imaging apparatus 301 is assumed to be located right above the dashboard, but the height (height in the vehicle) of the imaging apparatus 301 is not particularly limited as long as the height is a height equal to or more than the height of the dashboard and the position is a position lower than the assumed gaze. Furthermore, here, the imaging apparatus 301 is arranged on the dashboard as corresponding to the left end of the assumed range of the face direction in the yaw direction, but may be arranged on a left A-pillar.

The imaging apparatus 302 is an imaging apparatus corresponding to a position of a gaze when the driver confirms a right door mirror, and is arranged on a right A-pillar of the vehicle 100. The imaging apparatus 302 is disposed at a position and in a posture assumed to face the driver when the driver confirms the right door mirror. Therefore, the imaging apparatus 302 is disposed in a posture of imaging a position of the driver's seat where the face of the driver is assumed to exist. Here, the height of the imaging apparatus 302 is not particularly limited as long as the position is a position lower than the assumed gaze. By arranging the imaging apparatus 302 at the position lower than the gaze, it is possible to reduce an influence of eyelashes on the gaze estimation.

The imaging apparatus 303 is an imaging apparatus corresponding to a position of a gaze when the driver confirms the right rear, and is arranged on the right C-pillar. Here, the imaging apparatus 303 is located at the right end of the assumed range of the face direction in the yaw direction. The imaging apparatus 303 is disposed at a position where a focal length can be secured when the driver looks to the right. Therefore, the imaging apparatus 301 may be arranged at a position where the distance with respect to the position where the face of the driver in the driver's seat is assumed to exist is farther than the right B-pillar, and may be arranged, for example, at the right D-pillar. The height of the imaging apparatus 303 may be the same as that of another imaging apparatus (in particular, the imaging apparatuses 301 and 302), for example, in consideration of combining with a captured image of another imaging apparatus. The imaging apparatus 303 is disposed in a posture of imaging a position of the driver's seat where the face of the driver is assumed to exist.

The imaging apparatus 304 is arranged on the right B-pillar. The imaging apparatus 303 is disposed at a position where a focal length can be secured when the driver looks to the right. Therefore, the imaging apparatus 304 is arranged at a position where the distance with respect to the position where the face of the driver in the driver's seat is assumed to exist is closer than the right C-pillar. The height of the imaging apparatus 304 may be the same as that of another imaging apparatus (in particular, the imaging apparatuses 301 to 303), for example, in consideration of combining with a captured image of another imaging apparatus. The imaging apparatus 304 is disposed in a posture of imaging a position of the driver's seat where the face of the driver is assumed to exist. Further, for example, the imaging apparatus 304 may be arranged such that an assumed position of the driver's face is located at a minimum focal length.

Further, the imaging apparatus 110 may include an imaging apparatus arranged at a position that is not a position corresponding to an assumed face direction. By using a captured image of the imaging apparatus arranged at such a position, it is possible to provide a combined image in which more accurate estimation can be performed in a case of performing image processing such as gaze estimation of the driver from the combined image. The imaging apparatus 305 is arranged on the left C-pillar. The imaging apparatus 305 is disposed in a posture of imaging a position of the driver's seat where the face of the driver is assumed to exist. The imaging apparatus 305 is disposed so as not to include a person sitting on the passenger seat in an angle of view as much as possible by imaging the driver's seat from the left C-pillar.

The imaging apparatus 306 is disposed at the passenger seat (for example, the side surface). The imaging apparatus 306 is disposed in a posture of imaging a position of the driver's seat where the face of the driver is assumed to exist. The imaging apparatus 306 is disposed so as not to include a person sitting on the passenger seat in the angle of view by imaging the driver's seat from the passenger seat. The imaging apparatus 306 can also be used instead of the imaging apparatus 305 in a case where the person sitting on the passenger seat or the passenger seat itself is captured by the imaging apparatus 305 (due to a change in angle of the backrest of the passenger seat or the like). The height of the imaging apparatus 306 may be the same as that of another imaging apparatus, for example, in consideration of combining with a captured image of another imaging apparatus.

The imaging apparatus 307 is disposed on the ceiling. The imaging apparatus 307 may be a wide-angle camera such as a fisheye camera, for example. According to the wide-angle camera disposed on the ceiling, it is possible to acquire a captured image that is hardly affected by ambient light. For example, the captured image by the wide-angle camera may be used in provisional estimation processing to be described later. On the other hand, the imaging apparatus 307 may be a camera arranged in a posture of imaging a position where the face of the driver is assumed to exist. The arrangement position of the imaging apparatus 307 is not particularly limited as long as it is a ceiling, but may be arranged on the front side of the vehicle (at least ahead of a headrest of the driver's seat) in consideration of imaging of the driver. Here, it is assumed that the imaging apparatus 307 is arranged at a front position, which is the center between the left and right, on the ceiling of the vehicle 100.

As described above, the imaging apparatuses included in the imaging apparatus 110 may be arranged at the same height (common height) in the vehicle in consideration of combining the captured image with a captured image by another imaging apparatus. Here, it is assumed that each imaging apparatus is arranged at a height closest to a height of an assumed gaze among heights that can be set as a common height. Note that the imaging apparatus 110 may include an imaging apparatus different from the imaging apparatuses 301 to 307. The disposed imaging apparatus may be capable of controlling a posture for imaging.

Note that, in FIG. 3, an example of the imaging apparatuses having an arrangement corresponding to a plurality of assumed face directions of the driver has been described assuming that the vehicle 100 is a mobile object that travels on a Japanese automobile road. However, this is merely an example, and different face directions are assumed according to the type of the mobile object, the environment in which the mobile object moves, or the like, and the imaging apparatus may be arranged at a position corresponding to the face direction. For example, in a case where the mobile object is a four-wheeled vehicle with a left steering wheel, the arrangement of the imaging apparatuses illustrated in FIG. 3 may be laterally reversed with respect to the vehicle.

The imaging apparatus 110 according to the present embodiment can generate a combined image obtained by imaging the face of the driver by combining captured images by the respective imaging apparatuses. Hereinafter, when simply referred to as a “combined image”, it is assumed that the combined image indicates a combined image of captured images captured by two or more imaging apparatuses included in such an imaging apparatus 110. Therefore, it is assumed that calibration is executed in advance for the captured image included in the imaging apparatus 110, and each captured image can be combined. Since the calibration of the imaging apparatus and the processing of combining the captured images can be executed using any known processing, detailed description thereof will be omitted here.

Next, processing that can be executed by the imaging apparatus 110 according to the present embodiment will be described. The imaging apparatus 110 according to the present embodiment estimates the face direction or the gaze direction of the driver during the operation of the vehicle. The estimation processing of the face direction or the gaze direction described here is processing for acquiring information used for control of the imaging apparatus 110, and is assumed to be provisional estimation processing in which estimation accuracy may be lower than estimation accuracy of main estimation processing using a weight to be described later. Hereinafter, such provisional estimation processing of the face direction or the gaze direction may be referred to as “provisional estimation (processing)”.

The imaging apparatus 110 can execute the provisional estimation processing based on the captured image. Here, an imaging apparatus for capturing a captured image for the provisional estimation processing may be provided separately from the imaging apparatus illustrated in FIG. 3, or any of the imaging apparatuses 301 to 307 including the imaging apparatus 307 may be used. Further, the provisional estimation processing may be performed based on captured images by the plurality of imaging apparatuses 301 to 307.

In the provisional estimation processing, for example, in a case where the movement of the driver is not detected, the imaging apparatus 110 can estimate the face direction (or gaze direction) assuming that the driver is facing the front. In that case, the imaging apparatus 110 can predict the subsequent face direction (or gaze direction) based on a temporal estimation result of the face direction (or gaze direction). For example, the imaging apparatus 110 can predict and estimate the face direction based on the face direction, the change direction of the face direction, and the change speed of the face direction estimated in the preceding provisional estimation processing.

Furthermore, for example, the provisional estimation processing can also be executed using known face direction or gaze direction detection technology. For example, the imaging apparatus 110 can identify the face direction from the face image and estimate the gaze direction based on the pupil position or the like of the face image. Furthermore, for example, the imaging apparatus 110 may use the identified face direction as a rough gaze direction in subsequent processing. Furthermore, for example, the imaging apparatus 110 may perform the provisional estimation processing by using a learned machine learning model so as to output the face direction or the gaze direction of the driver using the face image of the driver as an input, or may perform the provisional estimation processing by information acquired by a sensor different from the imaging apparatus that detects the face direction or the gaze direction without using the captured image.

Note that, here, calibration of each imaging apparatus is performed in advance, and the face direction and the gaze direction from the face position of the driver estimated by the provisional estimation processing and the position of each imaging apparatus are calculated in the same coordinate system in a computable manner.

Next, the imaging apparatus 110 according to the present embodiment sets a weight for each imaging apparatus based on the face direction or the gaze direction estimated by the provisional estimation processing. Next, the imaging apparatus 110 estimates the face direction or the gaze direction of the operator by processing using the set weight based on the captured image captured by each imaging apparatus using the set weight. The estimation processing using such a weight may be referred to as “main estimation processing” below in order to be distinguished from the provisional estimation processing described above. Furthermore, in the following, when simply referred to as a “weight”, it is assumed that the weight indicates a weight set for each such imaging apparatus.

In the main estimation processing, the imaging apparatus 110 combines captured images by the respective imaging apparatuses to generate a combined image. Here, the imaging apparatus 110 can generate a combined image by causing each imaging apparatus to execute imaging processing in a drive state according to the set weight and combining captured images obtained by the imaging processing.

First, control processing of the drive state according to the weight according to the present embodiment will be described. Considering the processing of estimating the gaze of the driver, it is conceivable that while the captured image by the imaging apparatus at a position where the face direction or the gaze direction of the driver is close is important, for example, importance of a captured image obtained by imaging the driver from behind is relatively low. Therefore, for such an imaging apparatus with low importance, the processing load and power consumption can be reduced by reducing the imaging rate or suppressing the drive state such as setting the imaging apparatus to the standby state (standby state in which imaging is not performed).

As described above, the imaging apparatus 110 causes each imaging apparatus to execute imaging in the drive state according to the weight. Here, an imaging apparatus in which the weight is set to 0 to 1 and the weight is set to 1 performs normal imaging. As for the drive state of each imaging apparatus, for example, as the weight decreases, the drive state is controlled in the order of reducing the resolution (for example, the weight of 0.7 or less), reducing the imaging rate (for example, the weight of 0.5 or less), setting the imaging apparatus to the standby state (for example, the weight of 0.3 or less), and turning off the power supply (for example, the weight of 0.1 or less). The control content of the drive state is an example, and different control may be executed as long as the control reduces the processing load or power consumption. Furthermore, for example, the drive state of each imaging apparatus may be controlled such that the resolution, the rate, or both are reduced (the power supply is turned off at the weight of zero) as the weight decreases.

Next, weight setting processing according to the present embodiment will be described. Here, the imaging apparatus 110 can set a weight for each imaging apparatus based on the face direction or the gaze direction estimated by the provisional estimation processing and the position of each imaging apparatus. For example, the imaging apparatus 110 can set the weight such that the weight in the imaging apparatus at the closest position becomes largest with respect to the face direction or the gaze direction estimated by the provisional estimation processing. Here, the closeness of the imaging apparatus with respect to the face direction or the gaze direction is evaluated based on a difference between the direction from the position of the face to the imaging apparatus and the face direction or the gaze direction. Furthermore, for example, a predetermined number (for example, five) of imaging apparatuses may be selected in ascending order of the difference between the face direction or the gaze direction estimated by the provisional estimation processing and the direction toward the imaging apparatus, and the weight may be set such that the smaller the difference, the larger the weight (for example, 1, 0.8,0.6,0.4, and 0.2 are sequentially set). Furthermore, here, the description has been given assuming that imaging with the weight of zero as described above is not driven (the power supply is turned off). However, although the captured image is generated, the processing load can be reduced by not using the captured image in the main estimation processing.

Furthermore, for example, the weight may be set in two stages of 1 or 0 instead of setting in a plurality of stages as described above. In that case, the imaging apparatus set to 1 performs imaging to generate a combined image, and the imaging apparatus set to 0 does not perform imaging. For example, the weight may be set to 0 only for an imaging apparatus in which the difference between the face direction or the gaze direction estimated by the provisional estimation processing and the direction toward the imaging apparatus is within a predetermined threshold angle. Furthermore, for example, a table in which the weight according to the position is associated for each imaging apparatus with respect to the face direction or the gaze direction is prepared, and the weight may be set to each imaging apparatus by referring to the table.

Furthermore, the imaging apparatus 110 according to the present embodiment may perform the main estimation processing using the weight by estimating the face direction or the gaze direction for each captured image by each imaging apparatus and integrating the estimation results of the face direction or the gaze direction. In this case, the main estimation processing may be executed by capturing the captured image assuming that the drive state of the imaging apparatus is set according to the weight as described above, and integrating the estimation results of the face direction or the gaze direction from the respective captured images. Furthermore, for example, the main estimation processing may be executed such that each of estimation results of the face direction or the gaze direction from the captured image captured by the imaging apparatus in the normal drive state is weighted and summed using the set weight to be the entire estimation result.

Since the estimation processing of the face direction or the gaze direction based on the plurality of captured images as described above can be executed by known estimation processing of the face direction or the gaze direction, a specific description regarding actual calculation will be omitted. Here, the description has been given assuming that the “face direction or the gaze direction” is estimated in both the provisional estimation processing and the main estimation processing. However, differently from this, for example, the face direction may be estimated in the provisional estimation processing, and the gaze direction may be estimated in the main estimation processing. In the provisional estimation processing, the face direction that is relatively easily estimated is estimated, and the gaze direction is estimated in the main estimation processing based on the estimation result, so that the processing load regarding the estimation of the gaze can be further reduced.

Furthermore, here, reduction of the processing load by lowering of the weight of the imaging apparatus far from the face direction or the gaze direction has been described. On the other hand, since it is expected that the accuracy of the gaze estimation similarly decreases even in the captured image in which the degree of noise is strong, it is also conceivable to lower the weight for the imaging apparatus having a large amount of noise. From such a viewpoint, the imaging apparatus 110 can evaluate the noise amount of the captured image captured by each imaging apparatus and set the weight further based on the noise amount. In this case, for example, in addition to the setting of the weight described above, an imaging apparatus having a noise amount equal to or greater than a certain amount may not be used (the weight is set to zero), and the weight may be corrected according to the noise amount (for example, correction of 1.0 to 0 times is performed according to the noise amount). Here, as an example, it is assumed that an imaging apparatus that captures a captured image in which the noise amount is equal to or greater than a predetermined threshold is not used in the main estimation processing (the weight is set to zero). The noise amount can be evaluated by a general method for evaluating the noise amount in an image.

Hereinafter, a case where the main estimation processing is performed only by some imaging apparatuses as a result of setting the weight to 1 or 0 with respect to the face direction of the driver estimated by the provisional estimation processing will be described in a plurality of patterns. FIG. 4 is a diagram for explaining an imaging apparatus used in the main estimation processing in a case where a driver 400 has four patterns of face directions 401 to 404 in a vehicle 100 in which the imaging apparatus 110 has the arrangement illustrated in FIG. 3.

Note that, here, the imaging apparatus 307 arranged on the ceiling is not basically used, and the imaging apparatus 305 and the imaging apparatus 306 are used according to the situation. Furthermore, among the imaging apparatuses 301 to 304, the imaging apparatuses 301 and 302 that are disposed relatively in front and are capable of imaging the pupil of the driver in a basic posture during driving are used in the main estimation processing regardless of the face direction of the driver 400.

The driver 400 is a driver sitting on the driver's seat of the vehicle 100. The face direction 401 is a face direction when the driver 400 looks to the front. In this case, only the imaging apparatuses 301 and 302 imaging the driver from a front facing direction are driven and used in the main estimation processing. According to such control, only the two imaging apparatuses having the minimum configuration in the basic posture facing the front during driving are driven, and then the estimation accuracy of the gaze at the time of confirming the left and right door mirrors corresponding to the positions of these imaging apparatuses can be improved.

The face directions 402 and 403 are face directions when the driver confirms the right rear side of the vehicle 100, and the face direction 402 is directed further rearward than the face direction 403. In the face direction 402, in addition to the imaging apparatuses 301 and 302, the imaging apparatus 303 arranged in the right C-pillar is driven and used in the main estimation processing. Furthermore, in the face direction 403, in addition to the imaging apparatuses 301 and 302, the imaging apparatus 304 arranged in the right B-pillar is driven and used in the main estimation processing. According to such control, it is possible to improve the estimation accuracy of the gaze at the time of right rear confirmation while similarly reducing the processing load for each of the face direction 402 and the face direction 403 (here, while the number of imaging apparatuses to be driven is suppressed to three).

The face direction 404 is a face direction when the driver is confirming the left rear of the vehicle 100. In the face direction 404, in addition to the imaging apparatuses 301 and 302, the imaging apparatus 305 arranged in the left C-pillar or the imaging apparatus 306 arranged in the passenger seat is driven and used in the main estimation processing. Here, the imaging apparatuses 305 and 306 may be used at the same time, or the imaging apparatus 305 or 306 may be used according to the state of the passenger seat.

Furthermore, for example, at the time of estimating the face direction or the gaze direction of the driver in the provisional estimation processing, for example, only the imaging apparatus 307 can be driven. In such provisional estimation processing, the imaging apparatuses 301 to 306 can be arbitrarily driven to use the captured image for the provisional estimation processing. Furthermore, by arranging an imaging apparatus (for example, on the rear seat side) separately from these imaging apparatuses 301 to 307 and using the imaging apparatuses together, it is possible to simultaneously confirm the situation inside the vehicle.

According to such a configuration, it is possible to arrange a plurality of imaging apparatuses including optical sensors arranged to capture the face image of the operator inside the mobile object at respective positions corresponding to the plurality of face directions of the operator assumed during the operation of the mobile object. Therefore, it is possible to accurately estimate the face direction and the gaze direction even when the face direction or the gaze direction of the operator changes. In addition, the main estimation processing using the weight set according to the face direction or the gaze direction estimated by the provisional estimation processing enables accurate gaze direction estimation while reducing the processing load and the power consumption.

Note that, in the present embodiment, the description has been given assuming that the face direction is estimated based on the captured image in the provisional estimation processing. However, as described above, the provisional estimation processing is provisional estimation processing performed for the main estimation processing, and is not limited to such processing as long as a direction in which the driver is facing can be roughly estimated. For example, the imaging apparatus 110 may perform the provisional estimation processing on the assumption that the driver is facing in a direction indicated as the movement destination by a blinker or a car navigation. Furthermore, for example, information of a person outside the vehicle 100 may be acquired, and the provisional estimation processing may be performed with a direction from the head of the driver to the person having the smallest time to collision (TTC) as the face direction. Furthermore, for example, the imaging apparatus 110 may perform the provisional estimation processing of estimating the face direction of the driver based on traffic information outside the vehicle, such as assuming that the driver is facing in a direction of a sign within a predetermined distance in front of the vehicle 100, or assuming that the driver confirms a meter in a case where there is a predetermined character (for example, a speed limit “60”) on a road surface in front of the vehicle 100. Furthermore, for example, in a case where a sound with a volume equal to or higher than a certain level (crying of a baby, abnormal noise of a tire, voice of a person in a passenger seat, or the like) is detected by an in-vehicle sensor, the imaging apparatus 110 may perform the provisional estimation processing on the assumption that the driver is facing a generation position of the sound. Furthermore, for example, the imaging apparatus 110 may recognize the utterance of a person in the vehicle by the in-vehicle sensor, and perform the provisional estimation processing on the assumption that the driver is facing in a specific direction in a case where information (for example, statement “look forward” or the like made by the person sitting in the passenger seat) suggesting the specific direction is detected.

Furthermore, since a plurality of imaging apparatuses are used in the arrangement according to the present embodiment, the shape of the head of the operator of the mobile object may be estimated using some or all of such imaging apparatuses. The head shape estimated here can be used for estimation processing of the face direction or the gaze direction in the main estimation processing, and this can particularly improve estimation accuracy of the face direction.

### Summary of Embodiments

The above embodiments disclose at least the following imaging apparatus.

1. An imaging apparatus according to the above embodiment, comprises:

a plurality of imaging apparatuses including optical sensors provided inside a mobile object and arranged to capture a face image of an operator inside the mobile object, wherein

the plurality of imaging apparatuses are arranged at positions corresponding to a plurality of assumed face directions of the operator during an operation of the mobile object.

According to this embodiment, it is possible to accurately estimate the face direction and the gaze direction even when the face direction of the operator changes.

2. In the imaging apparatus according to the above embodiment,

the plurality of assumed face directions include a face direction assumed when the operator operates the mobile object.

According to this embodiment, it is possible to arrange the imaging apparatus according to the face direction assumed during the operation of the operator.

3. In the imaging apparatus according to the above embodiment,

the plurality of assumed face directions include a face direction assumed when the operator confirms a periphery of the mobile object.

According to this embodiment, it is possible to arrange the imaging apparatus according to the face direction assumed when the operator confirms the surroundings.

4. In the imaging apparatus according to the above embodiment,

the plurality of assumed face directions include a face direction assumed when the operator confirms a peripheral monitoring device included in the mobile object.

According to this embodiment, it is possible to arrange the imaging apparatus according to the face direction assumed during the operation of the peripheral monitoring device by the operator.

5. In the imaging apparatus according to the above embodiment,

the peripheral monitoring device is a mirror included in a vehicle.

According to this embodiment, it is possible to arrange the imaging apparatus according to the face direction assumed during the confirmation of the mirror by the operator.

6. In the imaging apparatus according to the above embodiment,

each of the plurality of imaging apparatuses is arranged at the same height.

According to this embodiment, it is possible to efficiently combine captured images.

7. The imaging apparatus according to the above embodiment, further comprises:

a first estimation unit configured to estimate a first face direction or a first gaze direction of the operator during an operation of the mobile object;

a setting unit configured to set a weight for each imaging apparatus based on the first face direction; and

a second estimation unit configured to estimate a second face direction or a second gaze direction of the operator based on a captured image captured by each imaging apparatus by using the weight.

According to this embodiment, it is possible to estimate the face direction or the gaze direction using a plurality of imaging apparatuses based on provisional face direction estimation processing.

8. In the imaging apparatus according to the above embodiment,

the second estimation unit estimates the second face direction or the second gaze direction of the operator based on the captured image captured by each imaging apparatus in a drive state according to the weight.

According to this embodiment, the processing load and the power consumption can be reduced by setting the drive state of the imaging apparatus according to the estimation result of the face direction.

9. In the imaging apparatus according to the above embodiment,

the second estimation unit estimates the second face direction or the second gaze direction by integrating, based on the weight, the face direction or the gaze direction of the operator estimated from the captured image captured by each imaging apparatus.

According to this embodiment, it is possible to reduce the processing load and the power consumption by performing integration processing of the face direction or the gaze direction according to the estimation result of the face direction.

10. In the imaging apparatus according to the above embodiment,

the setting unit sets the weight for each imaging apparatus based on the first face direction or the first gaze direction and a position of the imaging apparatus.

According to this embodiment, it is possible to reduce the processing load and the power consumption by using an appropriate imaging apparatus according to the estimated face direction.

11. In the imaging apparatus according to the above embodiment,

the setting unit sets the weight such that a weight of the imaging apparatus in which the first face direction or the first gaze direction is closest is largest.

According to this embodiment, it is possible to select an imaging apparatus most suitable for the estimated face direction.

12. The imaging apparatus according to the above embodiment, further comprises:

a third estimation unit configured to estimate a third face direction of the operator based on a temporal estimation result of the first face direction or the first gaze direction, wherein

the setting unit sets the weight for each imaging apparatus based on the third face direction.

According to this embodiment, it is possible to estimate and use a rough face direction from a temporal estimation result of the face direction.

13. The imaging apparatus according to the above embodiment, further comprises:

an evaluation unit configured to evaluate an amount of noise for each of a plurality of captured images by the plurality of imaging apparatuses, wherein

the setting unit sets the weight based on the amount of noise in addition to the first face direction or the first gaze direction.

According to this embodiment, it is possible to reduce the processing load and the power consumption by using an appropriate imaging apparatus in consideration of the noise amount.

14. In the imaging apparatus according to the above embodiment,

the setting unit sets the weight for the corresponding imaging apparatus to 0 in a case where the amount of noise evaluated by the evaluation unit is a predetermined threshold or more.

According to this embodiment, it is possible to appropriately reduce the processing load and the power consumption by not using the imaging apparatus with much noise.

15. The imaging apparatus according to the above embodiment, further comprises:

a fourth estimation unit configured to estimate a shape of a head of the operator based on a plurality of captured images by the plurality of imaging apparatuses.

According to this embodiment, it is possible to more accurately estimate the face direction.

Heretofore, embodiments of the invention have been described above.

The invention is not limited to the foregoing embodiments, and various variations/changes are possible within the spirit of the invention.

What is claimed is:

1. An imaging apparatus, comprising:
a plurality of imaging apparatuses including optical sensors provided inside a mobile object and arranged to capture a face image of an operator inside the mobile object, wherein
the plurality of imaging apparatuses are arranged at positions corresponding to a plurality of assumed face directions of the operator during an operation of the mobile object.

2. The imaging apparatus according to claim 1, wherein
the plurality of assumed face directions include a face direction assumed when the operator operates the mobile object.

3. The imaging apparatus according to claim 1, wherein
the plurality of assumed face directions include a face direction assumed when the operator confirms a periphery of the mobile object.

4. The imaging apparatus according to claim 3, wherein
the plurality of assumed face directions include a face direction assumed when the operator confirms a peripheral monitoring device included in the mobile object.

5. The imaging apparatus according to claim 4, wherein
the peripheral monitoring device is a mirror included in a vehicle.

6. The imaging apparatus according to claim 1, wherein
each of the plurality of imaging apparatuses is arranged at the same height.

7. The imaging apparatus according to claim 1, further comprising:
a first estimation unit configured to estimate a first face direction or a first gaze direction of the operator during an operation of the mobile object;
a setting unit configured to set a weight for each imaging apparatus based on the first face direction; and
a second estimation unit configured to estimate a second face direction or a second gaze direction of the operator based on a captured image captured by each imaging apparatus by using the weight.

8. The imaging apparatus according to claim 7, wherein
the second estimation unit estimates the second face direction or the second gaze direction of the operator based on the captured image captured by each imaging apparatus in a drive state according to the weight.

9. The imaging apparatus according to claim 7, wherein
the second estimation unit estimates the second face direction or the second gaze direction by integrating, based on the weight, the face direction or the gaze direction of the operator estimated from the captured image captured by each imaging apparatus.

10. The imaging apparatus according to claim 8, wherein
the setting unit sets the weight for each imaging apparatus based on the first face direction or the first gaze direction and a position of the imaging apparatus.

11. The imaging apparatus according to claim 10, wherein
the setting unit sets the weight such that a weight of the imaging apparatus in which the first face direction or the first gaze direction is closest is largest.

12. The imaging apparatus according to claim 8, further comprising:
a third estimation unit configured to estimate a third face direction of the operator based on a temporal estimation result of the first face direction or the first gaze direction, wherein
the setting unit sets the weight for each imaging apparatus based on the third face direction.

13. The imaging apparatus according to claim 8, further comprising:
an evaluation unit configured to evaluate an amount of noise for each of a plurality of captured images by the plurality of imaging apparatuses, wherein
the setting unit sets the weight based on the amount of noise in addition to the first face direction or the first gaze direction.

14. The imaging apparatus according to claim 13, wherein
the setting unit sets the weight for the corresponding imaging apparatus to 0 in a case where the amount of noise evaluated by the evaluation unit is a predetermined threshold or more.

15. The imaging apparatus according to claim 1, further comprising:
a fourth estimation unit configured to estimate a shape of a head of the operator based on a plurality of captured images by the plurality of imaging apparatuses.
